(19) United States
(12) Patent Application Publication
(10) Pub. No.: US 2016/0202150 A1
(43) Pub. Date: Jul. 14, 2016

(54) LASER MICRODISSECTION SYSTEM AND LASER MICRODISSECTION SYSTEM METHOD

(71) Applicant: LEICA MICROSYSTEMS CMS GMBH, Wetzlar (DE)

(72) Inventor: Falk Schlaudraff, Butzbach (DE)

(73) Assignee: LEICA MICROSYSTEMS CMS GMBH, Wetzlar (DE)

(21) Appl. No.: 14/914,014

(22) PCT Filed: Aug. 19, 2014
(86) PCT No.: PCT/EP2014/067664

§ 371 Date: Feb. 24, 2016

(30) Foreign Application Priority Data
Aug. 30, 2013 (DE) 10 2013 109 481.3

(51) Int. Cl. G01N 1/06

(52) U.S. Cl. CPC G01N 1/06; G01N 2001/045

(57) ABSTRACT

A laser microdissection system includes a microscope that includes a reflected light device having a laser deflector which guides a laser beam provided by a laser through a microscope objective of the microscope onto a sample region for receiving a biological sample and which moves a point of impingement of the laser beam in the sample region. The laser microdissection system also includes a rinsing device comprising fluid dispenser configured to provide a suspension fluid in the sample region and a fluid remover arranged on the rinsing device configured to remove a suspension produced using the suspension fluid from the sample region.

### CROSS REFERENCE TO RELATED APPLICATIONS

This application is a U.S. National Stage Application under 35 U.S.C. §371 of International Application No. PCT/EP2014/067664 filed on Aug. 19, 2014, and claims benefit to German Patent Application Nos. DE 10 2013 109 481.3 filed on Aug. 30, 2013. The International Application was published in German on Mar. 5, 2015 as WO 2015/028356 under PCT Article 21(2).

### FIELD

The invention relates to a laser microdissection system and a laser microdissection method.

### BACKGROUND

Methods for processing biological samples by means of laser microdissection have existed since the mid-1970s (see, for example, Isenberg, G. et al.: Cell surgery by laser micro-dissection: a preparative method. Journal of Microscopy, Volume 107, 1976, pages 19-24) and have been continuously developed ever since.

During laser microdissection, cells, tissue regions etc. can be isolated from a biological sample (“object”, “preparation”) and can be extracted as what is known as a dissection specimen. A particular advantage of laser microdissection is the brief contact of the sample with the laser beam, as a result of which said sample is hardly changed. The dissection specimen can then be extracted in a variety of ways (see for example Bancroft, J. D. and Gamble, M.: Theory and Practice of Histological Techniques. Elsevier Science, 2008, page 575, “Laser Microdissection” chapter).

For example, in known methods, a dissection specimen can be isolated from the sample by means of an infrared or ultraviolet laser beam, which dissection specimen falls into a suitable dissection specimen collection container under the influence of gravity. In the process, the dissection specimen can also be cut out of the sample together with an adherent membrane. In what is known as laser capture microdissection, however, a thermoplastic membrane is heated by means of an appropriate laser beam. In the process, the membrane fuses with the desired region of the sample and can be removed by means of tearing in a subsequent step. A further alternative consists in attaching the dissection specimen to a lid of a dissection specimen collection container by means of the laser beam. In known inverted microscope systems for laser microdissection, dissection specimens ejected upwards can also be attached to the base of a dissection specimen collection container which is provided with an adhesive coating.

Known microscope systems for laser microdissection, as are known for example from WO 98/14816 A1, comprise a reflected light device, into the beam path of which a laser beam is coupled. The laser beam is focussed on the sample by means of the respective microscope objectives used, the sample resting on a microscope stage which can be moved automatically by means of a motor. A cutting line is produced by the microscope stage being moved during cutting in order to move the sample relative to the stationary laser beam. However, this has the disadvantage inter alia that it is not easy to observe the sample while the cutting line is being produced, since said sample moves in the field of vision and the image may appear blurred.

Therefore, laser microdissection systems which comprise laser deflection devices or laser scanning devices designed to move the laser beam or the point of impingement thereof over a stationary sample are more advantageous. Laser microdissection systems of this kind, which also have particular advantages within the context of the present invention, are described in detail below. A particularly advantageous laser microdissection system which comprises a laser deflection device having glass wedges in the laser beam path which can be adjusted relative to one another, is described for example in EP 1 276 586 B1.

In both cases, i.e. both in laser microdissection systems in which the microscope is moved, and in laser microdissection systems which comprise a laser deflection device, pulsed lasers are generally used, each laser pulse producing a hole or a depression in the sample. A cutting line is produced by means of a series of successive, and possibly overlapping, holes or depressions of this kind.

Laser microdissection can be used for extracting individual cells or defined tissue regions, which are separated from surrounding tissue by means of a laser beam and subsequently undergo various diagnostic analysis methods for example. In oncology, laser microdissection can be used for example for isolating specific tumour cells from a microscopic cut and to examine said tumour cells for specific metabolites or proteins.

In conventional laser microdissection systems, microscope tissue cuts are used, which are usually produced by means of a microtome, processed and completely severed along the cutting line mentioned in order to extract the dissection specimen. It is not possible, for example, to isolate separately from one another materials of different tissue layers lying over one another. A dissection specimen extracted by means of conventional laser microdissection is therefore always a bulk sample through the entire thickness of the processed sample. Differentiation into individual tissue layers is not possible using laser microdissection, or can be achieved only indirectly from the thickness of the sample.

It is also conventionally not possible to process thicker samples, which are not pre-cut using a microtome, by means of laser microdissection, since material which may have been displaced out of the sample cannot be recovered. If it is necessary, for example, to extract a large amount of a particular tissue type or a particular tissue layer, a plurality of corresponding tissue cuts must be processed for this purpose. This is requires great effort and time.

### SUMMARY

In an embodiment, the present invention provides a laser microdissection system that includes a microscope having a reflected light device that has a laser deflector which guides a laser beam provided by a laser through a microscope objective of the microscope onto a sample region for receiving a biological sample and which moves a point of impingement of the laser beam in the sample region; a rinsing device comprising a fluid dispenser configured to provide a suspension fluid in the sample region; and a fluid remover arranged on the rinsing device configured to remove from the sample region a suspension produced using the suspension fluid.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of a laser microdissection system which can be used within the context of a method according to the invention.

FIG. 2 is a schematic view of a sample region of a laser microdissection system according to an embodiment of the invention.

FIG. 3 shows schematic representations of method steps in order to illustrate a method according to an embodiment of the invention.

### DETAILED DESCRIPTION

Improved options for processing biological samples by means of laser microdissection, in particular extracting sample material from defined tissue cuts together with subsequent morphological correlation possibilities, would be beneficial.

The present invention proceeds from a laser microdissection system which is known per se and comprises a microscope comprising a reflected light device having a laser deflection device, e.g. a laser deflector, for guiding a laser beam provided by a laser unit through a microscope objective of the microscope onto a sample region for receiving a biological sample and for moving a point of impingement of the laser beam in the sample region.

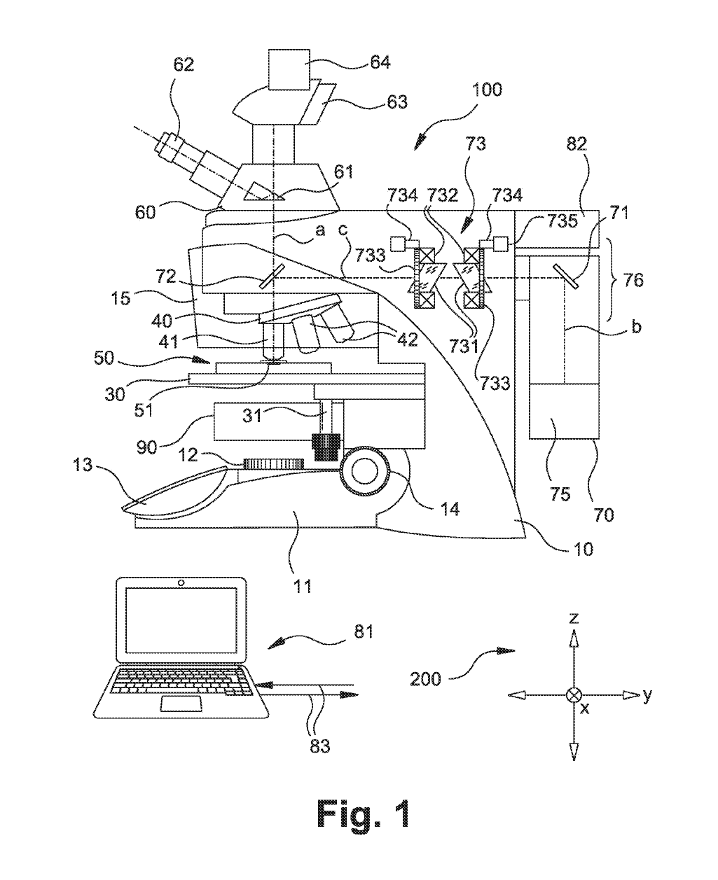

A corresponding laser microdissection system is described in detail below, with reference to FIG. 1. In a laser microdissection system of this kind, the reflected light device couples the laser beam from a laser light source into the observation beam path of the microscope. The laser beam is focussed on the sample by means of the microscope objective, which is also used to observe said sample. Thus, in other words, the beam path of the laser beam of the laser unit extends through the reflected light device and through the microscope objective, and intersects an object plane of the microscope objective at an adjustable intersection point which is specified to the laser deflection device by means of actuation signals.

In order to prevent misunderstanding, it should be emphasized here that the laser microdissection system implemented within the context of embodiments of the present invention can be used together with samples that have already been prepared so as to be suitable for microscopy. These can, for example, be thin cuts of tissue which have been separated from a larger tissue block by means of a microtome, but in the present case can also be thicker cuts from a corresponding tissue block. A tissue block of this kind can, for example, be a fixed organ or a biopsy of a corresponding organ. The laser microdissection system according to an embodiment of the invention therefore serves not only to extract samples, but also to process said samples and to isolate specific regions thereof. Of course, embodiments of the present invention can also be used in the case of samples which are not extracted by means of a microtome, e.g. in the case of smears, macerations, etc. As mentioned, however, embodiment of the invention are also suitable for processing thicker samples which have not been prepared by means of a microtome.

Microtomes are used only in preparing microscopic samples. Microtomes can also comprise lasers for this purpose. The cuts extracted by means of a microtome are applied to a microscope slide, as mentioned above, and optionally fastened thereto and stained, etc. Only then are said cuts available for use in the laser microdissection system. A microtome fundamentally differs in operation from a laser microdissection system inter alia in that cuts having as uniform cut thicknesses as possible are extracted thereby. Microtomes are therefore designed to produce a large number of identical cuts having parallel cutting surfaces, whereas laser microdissection systems are designed to separate out dissection specimens according to sample-dependent criteria, for example according to visual morphological criteria. In the present case, the laser microdissection system is used in particular for separating out sample particles which are subsequently incorporated in a suspension fluid. A person skilled in the art would therefore not apply technological solutions used in microtomes to laser microdissection systems of this kind, on account of the completely different goal.

In laser microdissection systems comprising a laser deflection device and used according to the invention, when processing the sample the microscope stage is fixed in position relative to the microscope objective with respect to the x-direction and the y-direction (i.e. perpendicular to the optical axis of the microscope objective).

In contrast to laser microdissection systems comprising a microscope stage (scanning stage) which is moved by means of a motor during the dissection process and which must, in particular in the case of highly magnifying objectives, have a high degree of positioning accuracy in order to make it possible to extract precise cuts, laser microdissection systems comprising a laser deflection device are simpler and more cost-effective to produce, and have advantages in terms of precision.

In a particularly advantageous embodiment, the laser deflection device comprises two thick glass wedge plates (“glass wedges”) which are inclined relative to an optical axis and can be rotated independently of one another about an optical axis, and which produce beam deflection on account of their wedge angle. The resultant deflection angle of the laser beam can be varied with respect to the optical axis by means of rotating the glass wedge plates. At the output of the laser deflection device, the laser beam has a lateral beam offset relative to the optical axis on account of the thickness and inclination of the glass wedge plates and, for all deflection angles, impinges on the centre of the objective pupil of the microscope objective. The intersection point of the laser beam with the object plane can thus be adjusted.

A laser deflection device of this kind is therefore particularly advantageous compared with other laser deflection devices such as mirror scanners, galvanometer scanners or stepper motor scanners, because it does not need to be arranged in a plane which is conjugate with the objective pupil. What is known as pupil imaging is therefore also not required in order to achieve the deflected beam striking the objective pupil. In the case of laser microdissection using UV laser light, pupil imaging suitable for UV would be required for example. Further advantages of a laser deflection device of this kind comprising wedge plates are mentioned for example in EP 1 276 586 B1.

A laser microdissection system according to an embodiment of the invention includes a rinsing device having fluid dispenser for providing a suspension fluid in the sample region, and fluid removal means for removing from the sample region a suspension produced using the suspension fluid.

As will be explained in more detail in the following, an embodiment of the present invention makes it possible to make cuts and ablations in a tissue or another biological sample in a targeted and exact manner, without fully severing said sample or without completely separating it from the surrounding tissue. The material extracted thereby, in the form of sample particles, can be specifically collected by means of the rinsing device. In this case, for example, a defined cell layer or a number of defined cell layers can be specifically removed, it being possible for the removed cells, cell fragments or cell networks (for example a particular tissue layer) to be made available for further examination.

As explained, in conventional laser microdissection systems, a corresponding planar cut on a microscope slide must always be completely severed by means of the laser beam used, in order to extract dissection specimens. It is therefore not possible to extract individual cell layers or tissue layers.

Conversely, however, individual tissue layers can optionally be ablated by means of conventional devices for laser ablation, without completely severing a tissue processed hereby, for example during an operation. Devices of this kind are used for example for intravital thrombosis induction or for manipulating tissue networks several hundred micrometres thick, or for manipulating cell cultures. However, laser ablation devices of this kind usually do not provide any possibility for recovering the ablated material. Recovery is possible, at best, in the case of manipulated cell cultures if said cultures grow on substrate materials suitable for laser microdissection and can be applied to an appropriate stage for collecting dissection specimens.

However, on account of the rinsing device of an embodiment of the present invention, every kind of sample and the respectively removed material present in the form of sample particles can be washed. In this case, a suitable suspension fluid is used, for example a buffer which is compatible with the sample and/or the subsequent examination method on account of its pH and/or its composition and can optionally also be tempered. In particular, an xy-microscope stage comprising additional collection containers for cut dissection specimens is not required. Transfer of the dissection specimens from the collection containers into separate reaction vessels for subsequent examination can likewise be omitted.

In the scope of this application, a “suspension” can be understood as being a heterogeneous substance mixture, the sample particles mentioned being distributed in a uniform or non-uniform manner in a corresponding “suspension fluid,” i.e. being “suspended.” The sample particles can also float on the surface of the suspension fluid, at least in part.

Suspending the sample particles means that said particles can be washed towards the fluid removal means. Of course, it is possible to use appropriate fluid conveying means, for example appropriate compartments or barriers on a sample holder, which prevent the suspension fluid or the suspension from flowing out of the sample in an uncontrolled manner.

According to an embodiment of the invention, a step of suspension and removal can also be carried out a number of times and stepwise per tissue layer for example, so that the sample can be cooled between the individual processing steps, for example by a cooled suspension fluid. Possible heating on account of the laser processing, and negative effects which may be produced thereby, can be reliably prevented in this way.

Fluid removal means comprising suction means for suctioning the suspension out of the sample region are particularly advantageous in this context. Suction means of this kind comprise a fluid line which is coupled to the fluid removal means. A fluid line of this kind can be connected to hydrostatic and/or pump-operated evacuation devices for producing appropriate suction, with the result that complete evacuation of the suspension is ensured, even in the case of a backup resulting from the sample particles for example.

The suction meals advantageously comprise fluid collection means for collecting the suspension and/or a fluid drained off therefrom. As a result, the suspension fluid can for example be recovered from a corresponding suspension and re-used. A fluid “drained off” from a suspension is extracted from the suspension for example by means of separating the sample particles using a filter.

Filtering the sample particles from the suspension obtained by means of the suspension fluid is particularly advantageous because it permits careful recovery of the sample particles. For this purpose, the suspension is suctioned by means of a suitable filter which is formed as part of the fluid removal means or is attached thereto. The sample particles on a corresponding filter can for example subsequently be received in a further buffer or further processed directly on the filter. Since the sample particles are present virtually dry on a corresponding filter, said particles can very quickly be completely dried, for example by means of freeze drying, and can subsequently be stored without any loss in quality.

Directly processing the sample particles on a corresponding filter, for example by means of colouring techniques, immunohistochemical techniques or molecular biology techniques, makes it possible, on account of the reduced volume, to save on reagents, which may be very expensive.

As an alternative to using a corresponding filter, it is of course also possible to evacuate the entire suspension and to extract the sample particles by means of centrifugation or simple sedimentation.

If filter means are used, it is particularly advantageous if said means are connected to the fluid removal means via a quick coupling. For example, the filter means can comprise membranes made of a pulp material or biologically compatible and/or chemically compatible plastics materials and attached in suitable cartridges. Corresponding cartridges can be placed on a support of the fluid removal means appropriately formed for this purpose or can be attached by means of appropriate couplings. A “quick coupling” is understood, in this context, as a coupling which can be released during operation and without using the remaining laser microdissection system, in particular without tools.

Corresponding filter means can thus be provided with replaceable filters, which can also be designed so as to be disposable. This prevents complex cleaning steps and reduces the risk of substances being carried over. Sterilisable filter cartridges can also be used for example.

In order to ensure that the corresponding sample material is extracted in a particularly controlled manner, a laser microdissection system according to the invention can also be equipped with a rinsing device which comprises at least a pressure gauge and/or adjustment means for adjusting a pressure and/or a volume flow of the suspension fluid and/or the suspension. As a result it is also possible to identify, for example, that a used filter is blocked, which is indicated for example by the fact that the suction required for evacuating a specific amount of fluid is above an expected value. The pressure gauge, which is designed for measuring a (negative) pressure or suction in a corresponding suction line, can in this case also emit a signal to a user information unit which indicates that the respective filters used need to be changed. A corresponding pressure value can also be used as a measure for a number of sample particles.

A laser microdissection system according to an embodiment of the invention is particularly advantageous when the rinsing device comprises a cooling device for cooling the suspension fluid and/or a temperature control device for providing a constant temperature of the suspension fluid. A cooled suspension fluid can be provided by a cooling device, which fluid makes it possible for example to extract temperature-sensitive sample material over a long period of time. Accordingly, cold suspension fluid can also be used in order to reduce the heating produced by the laser beam. A temperature control device can be designed in particular as a constant temperature heating system which makes it possible to achieve a constant temperature of the suspension fluid even in the case of varying ambient temperatures.

In a laser microdissection system according to an embodiment of the invention, the fluid removal means can also comprise detectors for detecting sample particles in the suspension. Detectors of this kind (which are also used in this case without filter means) can for example be counting chambers comprising photoelectric sensors in a fluid line for the suspension, which can identify the passage of individual or a plurality of sample particles. The detectors can thus be used for the purpose of quality control. If it is identified, for example, that a smaller number of sample particles than expected is obtained when a method is carried out, this may indicate problems in conducting the investigation, which are then to be identified in more detail.

If the described filter means are used, the described detectors can also be provided upstream of a corresponding filter. The detectors can also evaluate a corresponding filter by means of digital optics, and can detect the sample particles located thereon.

A further advantageous embodiment of the laser microdissection system according to an embodiment of the invention comprises, in order to configure the fluid dispenser to also provide a drying fluid in the sample region. The drying fluid can be provided via the same fluid channel as that for providing the suspension fluid, or via another fluid channel. For example air (optionally temperature-controlled and filtered so as to be free of germs and/or dust) and/or another suitable gas, for example an inert gas, can be used as the drying fluid. Drying using a drying fluid of this kind can occur at the end of a laser microdissection process or between individual method steps, for example before changing a suspension fluid.

According to an advantageous embodiment, the laser microdissection system comprises a microscope which is configured to examine structures beneath a surface of the sample. Said microscope can thus also be used for observing deep tissue layers (i.e. tissue layers beneath the surface of the sample and/or internal tissue layers). This makes it possible to predict the depth to which a corresponding tissue can be removed in order to extract as much material as possible, while at the same time if possible not contaminating said material with “foreign” material (i.e. material from a lower tissue layer). A microscope which is configured for examining structures beneath a surface of the sample can be formed, for example, as a confocal microscope, in particular as a spinning disk confocal microscope.

Said microscopes are particularly suitable for obtaining reliable depth information. A laser microdissection system according to the invention, which is further equipped with one of the types of microscope mentioned, thus also makes it possible for the method to be carried out mainly automatically. By repeated examination using a microscope of this kind, in each case following one or more processing steps, a corresponding sample can be removed continuously, layer by layer. In the process, a microscope used for this purpose, or an image evaluation unit associated with the microscope, can also automatically identify the individual tissue layers. The rinsing device can likewise be used automatically here in each case. Moreover, an automatic sampling system can also be used in a corresponding laser microdissection system, in which sampling system the suspensions can in each case be collected from separated tissue layers in different sample vessels. This makes it far simpler to extract sample material.

The present invention also relates to a corresponding laser microdissection method for extracting sample material from a biological sample. In the method according to the invention, the sample is introduced into a sample region of a laser microdissection system. As described above, sample particles are mobilised from the sample, i.e. separated out of the remaining sample in each case, by means of a laser beam.

According to the invention, as also described, a rinsing device comprising fluid dispenser and fluid removal means is used, a suspension fluid being provided by the fluid dispenser, the sample particles being suspended by means of the suspension fluid, and a suspension produced using the suspension fluid subsequently being removed from the sample region together with the sample particles.

The features and advantages of a method according to an embodiment of the invention have already been described with reference to the device according to the invention and the preferred embodiments thereof. Reference is therefore made to these explanations.

The laser microdissection method is used in particular in a laser microdissection system as described above, i.e. a laser microdissection system in which a laser beam provided by the laser unit is guided by the reflected light device, e.g. a reflector, mentioned through a microscope objective of the microscope onto the sample region and the sample received in the sample region, and is moved by means of the laser deflection device.

Significant advantages can be achieved if the sample particles are filtered out of the suspension in a laser microdissection method of this kind, if a sample is used which comprises a plurality of tissue layers and the sample particles are extracted from just one or a defined number of the tissue layers, and/or if a depression is produced in the sample by means of the laser beam, in which depression the sample particles can be suspended.

In FIG. 1, a laser microdissection system which can be used for carrying out a method according to the invention is shown schematically and is denoted as a whole by 100. Substantial parts of the laser microdissection system 100 correspond to the system disclosed in EP 1 276 586 B1, to which reference is also explicitly made here. A coordinate system, on the basis of which the axes and/or directions x, y and z mentioned below are illustrated, is denoted by 200 in FIG. 1.

The laser microdissection system 100 comprises a microscope 10. An illumination device 12 (shown here only in part) can be provided in a microscope foot 11 of the microscope 10. Said illumination device can for example be a light source and suitable means for influencing the illumination light provided by the light source, for example filters and/or diaphragms. A condenser unit 90 can be provided for the purpose of transillumination and for adjusting suitable methods of contrast and/or observation.

The microscope 10 can be formed as a confocal microscope, in particular as a spinning disk confocal microscope, and in this case comprises corresponding further or alternative means.

A user input unit and/or user information unit 13 can also be arranged at the microscope foot 11 for example, which unit can be formed as a touchscreen for example and via which the user can input and/or read out observation parameters and/or processing parameters for example.

In addition, a pinion knob 14 is provided. Said knob is used for controlling coarse and fine adjustment for setting a height of a microscope stage 30. A sample 51, which is located in a sample region 50, for example a tissue sample inserted in an appropriate holder, can thus be brought into an object plane of an objective 41. The objective 41 is fixed in a rotating nosepiece 40 along with further objectives 42. A protective cover 15 can be provided for protection against laser radiation.

Observation light emanating from the sample 51 extends along an observation beam path a. A preferably variable portion of the observation light, for example approximately 60°, can be outcoupled in a tubular unit 60 having appropriate outcoupling devices 61, and can be presented to a user by means of a pair of eyepieces 62. A further portion of the observation light can be coupled into a digital image capturing unit 63 and can be captured so as to produce an image. The image capturing unit 63 can be associated with an image evaluation module 64 locally, in a control unit 82 or a control terminal 81 (see below), or in another spatial arrangement.

The laser microdissection system 100 comprises a laser unit 70 having a laser light source 75. A laser beam b provided by the laser light source 75, which may be a UV laser light source for example, is deflected in a reflected light unit, denoted here as a whole by 76, on a first deflection mirror 71 and a second deflection mirror 72 and is focussed through the objective 41 onto the sample 51 in the sample region 50.

In the case of the laser microdissection system 100, the location at which the laser beam b impinges on the sample 51 in the object plane, and thus also in the sample region 50, can in principle be adjusted in a variety of manners. Firstly, a manual adjustment device 31 can be provided, by means of which the microscope stage 30, which is formed as a mechanical stage, can be adjusted in the x-direction and the y-direction (i.e. in this case perpendicular to the paper plane and in parallel with the paper plane respectively). In addition to the adjustment device 31, electromechanical adjustment means can be provided, which can be controlled by a control unit 82 and/or the position of which can be detected by the control unit 82 for example.

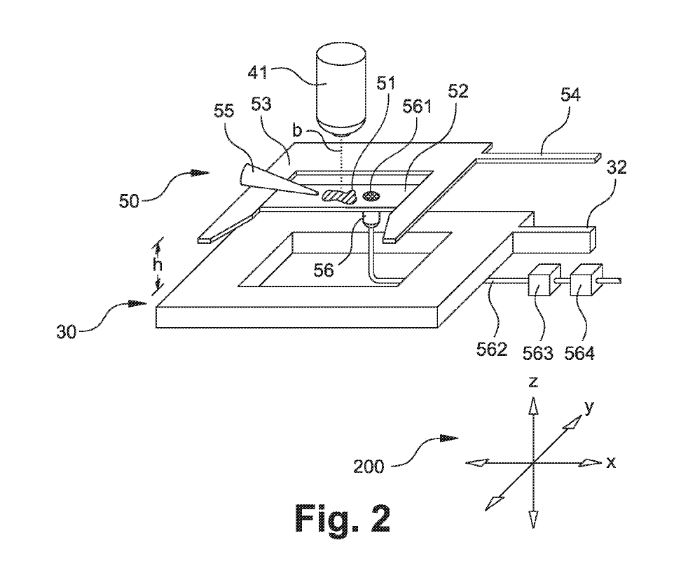

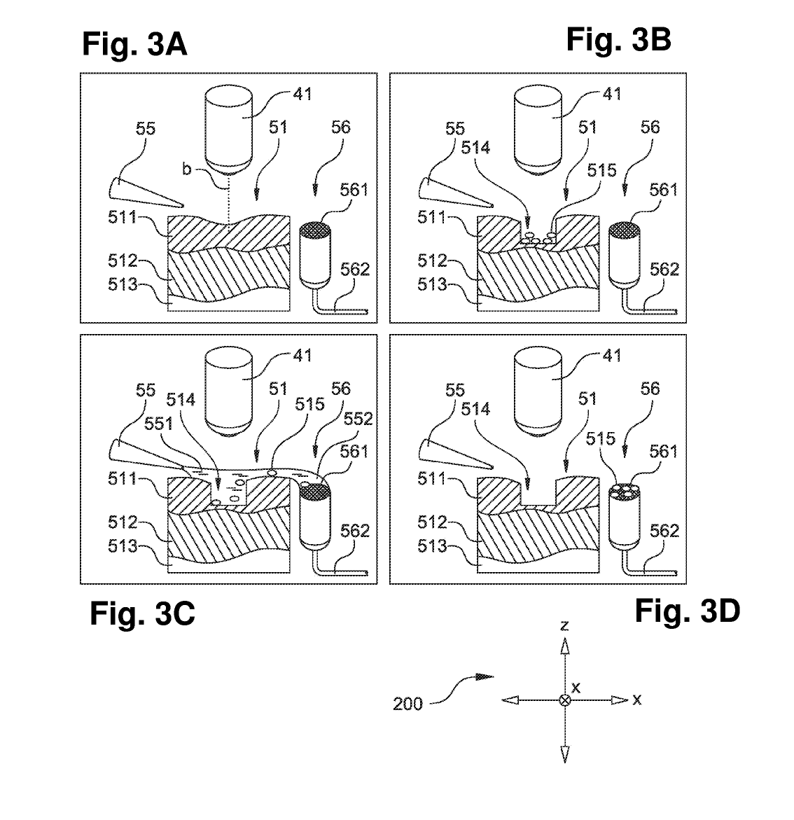

The control unit 82 can also control any number of further motorised functions of the laser microdissection system 100, and in particular can provide an interface to an external control terminal 81 which can be connected via suitable connections 83. The control unit 82 or the control terminal 81 can also evaluate data obtained by means of the image evaluation unit 64 for example. A sequence of tissue layers or other structures of the sample 51 for example can thus be detected. The control unit 82 or the control terminal 81 can also be used for controlling a rinsing device, as is shown in FIGS. 2 and 3 which follow.

In particular a laser deflector 73 can be provided for the laser microdissection. The laser beam b can be deflected by means of the laser deflector 73 relative to an optical axis c extending between the first deflection mirror 71 and the second deflection mirror 72. The laser beam can therefore impinge at different positions on the second deflection mirror 72, which can be formed as a dichromatic divider for example, and is thus also focussed at different positions on the sample 51 in the object plane. A deflection by means of a laser deflector 73 is shown in detail in EP 1 276 586 B1. It should be emphasised that different possible ways of deflecting a laser beam b and/or for positioning the sample 51 in the object plane relative to the laser beam b can be used here. The invention is not restricted to the example shown.

In the example shown, the laser deflector 73 comprises two solid glass wedge plates 731, which are inclined relative to the optical axis c and can be rotated independently of one another about the optical axis c. The wedge plates 731 are mounted by means of ball bearings 732 for this purpose. Each of the wedge plates is connected to a gear wheel 733. The gear wheels 733 can be rotated in each case by means of actuators 734, to which corresponding actuation signals can be applied and which accordingly drive the gear wheels 733. The rotation devices 734 can be provided with position transmitters 735 (here shown only on the right-hand actuator 734). A position detected by the position transmitters 735 can be transmitted to the control unit 82.

FIG. 2 is a schematic view of a sample region 50 of a laser microdissection system, for example the laser microdissection system 100 shown in FIG. 1, according to an embodiment of the invention.

FIG. 2 shows, in particular, a preferred embodiment of the rinsing device provided according to the invention. Said device is shown in a highly schematic manner and in reality comprises a plurality of further components such as pumps, fluid reservoirs, valves and/or gauges.

Fluid dispenser 55 for providing a suspension fluid in the (or on the) sample region 50, and fluid removal means 56 for removing from the sample region 50 a suspension produced using the suspension fluid, are provided as the central components of the rinsing device. The fluid dispenser 55 and the fluid removal means 56 will be described in greater detail below.

The sample 51 is arranged on a sample holder 52, for example a microscope slide or a corresponding device having fastening means for fastening the sample 51 and/or fluid conveying means. For the purpose of conveying fluid, the sample holder 52 can also be formed in the shape of a trough and/or comprise appropriate channels for conveying fluid. The sample holder 52 can for example be completely flooded with suspension fluid from the fluid dispenser 55. In this case, the fluid dispenser 55 can also be configured to dispense a defined amount of fluid, which does not exceed the capacity of the sample holder 52 or the ability thereof to receive fluid. For this purpose, the control means 82 and/or the control terminal 81 can also be appropriately parameterised for example.

The sample holder 52 can be guided on the microscope stage 30 in the x-direction and the y-direction (cf. the coordinate system 200 in this case too) by means of an appropriate sample guide 53. The sample guide 53 and the microscope slide 30 are shown here in a highly schematic manner. The sample guide 53 and the microscope slide 30 comprise appropriate adjustment means 54 and 32 respectively. The adjustment means 54 and 32 of the sample guide 53 and/or the microscope slide 30 can for example also be adjusted by means of an adjustment device 31 (cf. FIG. 1 for example) and/or can be controlled by means of an electric motor. At least the microscope slide 30 can also be adjusted in the z-direction, for example by means of a pinion knob 14 (cf. FIG. 1 for example).

Even if, in the example shown, a spacing h is shown between the microscope slide 30 and the sample guide 53, the sample guide 53 can also rest directly on the microscope slide 30. The sample guide 53 can also be formed so as to be movable relative to the microscope slide 30 at least in the x-direction and the y-direction.

A microscope objective 41 (cf. FIG. 1 for example) is also shown in FIG. 2, by means of which objective the laser beam b is guided into the object region 50. The laser beam b impinges on the sample 51 at a point of impingement which can be determined by a laser deflector 73 (cf. FIG. 1 for example).

The fluid dispenser 55 can be designed having one or more channels and are configured at least to provide the suspension fluid, which has been mentioned a number of times. For this purpose, the fluid dispenser 55 can, as mentioned, be coupled to fluid reservoirs and controlled for example manually and/or by means of a control unit 82 and/or a control terminal 81.

In the example shown, the fluid removal means 56 are formed as an outflow in the sample holder 52, but any other arrangement is also possible. Filter means 561 are provided at the inlet of the fluid removal means 56, which filter means can filter sample particles out of a suspension obtained using the suspension fluid (cf. in particular FIG. 3 in this case). As mentioned, the filter means 561, or appropriate filters, can also be arranged at different points or can be omitted (for example if the sample particles are to be extracted by means of centrifugation).

The fluid removal means 56 further comprise suction means 562 for evacuating a corresponding suspension from the sample region 50. Said suction means are shown here in a simplified manner as a line and can in practice be coupled to appropriate pumps, pistons, collecting tanks, etc.

In addition, the fluid removal means 56 are associated with a pressure gauge 563 for example, which can be designed to measure a negative pressure in the suction means 562. The pressure gauge 563 can be coupled to a control device 82 and/or a control terminal 81 for example (cf. FIG. 1 for example). Using the pressure gauge 563 makes it possible for example to make predictions regarding the coverage of the filter means 561 or a corresponding filter.

The fluid removal means 56 can also be associated with detectors 564 for example, which detectors can be designed to detect sample particles. This can be provided in particular if no filter means 561 are provided. In this case, the detectors 564 can comprise a photoelectric sensor and/or a photosensitive detector for example, and transmit corresponding counting pulses or other data (for example relating to a scattering of light) to a control unit 82 and/or a control terminal 81.

FIG. 3 shows, in sub-FIG. 3A to 3D, schematic representations of method steps in order to illustrate a method according to an embodiment of the invention. In this case, only some of the components, which have already been shown in FIG. 2, are shown again.

In a first method step according to sub-FIG. 3A, a sample 51 which, in the example shown, comprises three tissue layers 511 to 513, is processed by means of the laser beam b. The fluid dispenser 55 and the fluid removal means 56 are not in operation in this method step.

The method step according to sub-FIG. 3A is carried out until a depression 514 is produced in the sample 51 or in the top tissue layer 511 thereof, in accordance with sub-FIG. 3B. The laser beam is then switched off. Corresponding sample particles 515 are now present in the depression 514 in the sample 51, which particles are provided with a reference numeral in only one case.

In a subsequent method step according to sub-FIG. 3C, a suspension fluid 551, for example a suitable buffer, is introduced into the sample region, and thus into the depression 514 in the sample 51, by the fluid dispenser 55. As a result, the sample particles 515 are suspended in the suspension fluid 551, and a corresponding suspension 552 is obtained. Here, too, the illustration is highly simplified. In reality, as mentioned, appropriate fluid conveying means are provided, for example in an object holder 52 (cf. FIG. 2 for example).

The suspension 552 obtained can be removed from the sample region by the fluid removal means 56, for example by evacuation, either at the same time as or after introducing the suspension fluid 551 into the sample region and thus into the depression 514 in the sample 51. If filter means 561 are provided, the sample particles 515 are deposited thereon. If no filter means 561 are provided, the sample particles 515 can be removed in another manner.

After the sample 51 has been fully rinsed, all the sample particles 515 are removed from the depression 514 in the sample 51 or in the top tissue layer 511 thereof, as shown in sub-FIG. 3D and, in the example shown, are caught on the filter means 561. Said sample particles are thus available for subsequent examination. The method can be continued by processing the tissue layer 512, in a manner similar to FIG. 3A.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser microdissection system comprising:
a microscope including a reflected light device having a laser deflector which guides a laser beam provided by a laser through a microscope objective of the microscope onto a sample region for receiving a biological sample and which moves a point of impingement of the laser beam in the sample region;
a rinsing device comprising a fluid dispenser configured to provide a suspension fluid in the sample region; and
a fluid remover arranged on the rinsing device configured to remove from the sample region a suspension produced using the suspension fluid.

2. The laser microdissection system according to claim 1, wherein the fluid remover comprises a suction source configured to evacuate the suspension from the sample region.

3. The laser microdissection system according to claim 2, wherein the suction source comprises a fluid collector configured to collect the suspension and/or a fluid drained off of the suspension.

4. The laser microdissection system according to claim 1, wherein the fluid remover comprises a filter configured to extract suspended sample particles from the suspension.

5. The laser microdissection system according to claim 1, wherein the filter is connected to the fluid remover via a quick coupling.

6. The laser microdissection system according to claim 1, wherein the rinsing device comprises at least a pressure gauge and/or an adjustment device for adjusting a pressure and/or a volume flow of the suspension fluid and/or the suspension.

7. The laser microdissection system according to claim 1, wherein the rinsing device comprises a cooling device for cooling the suspension fluid and/or a temperature control device for providing a constant temperature of the suspension fluid.

8. The laser microdissection system according to claim 1, wherein the fluid remover comprises detectors configured to detect sample particles in the suspension.

9. The laser microdissection system according to claim 1, wherein the fluid dispenser is further configured to provide a drying fluid in the sample region.

10. The laser microdissection system according to claim 1, wherein the microscope is configured to examine structures beneath a surface of the sample.

11. A laser microdissection method for extracting sample material from a biological sample, the sample being introduced into a sample region of a laser microdissection system and sample particles being mobilized from the sample by a laser beam, the method comprising:
providing, in the sample region by a fluid dispenser, a suspension fluid, wherein the sample particles are suspended by the suspension fluid thereby producing a suspension, and
subsequently removing the suspension from the sample region together with the sample particles.

12. The laser microdissection method according to claim 11, further comprising:
guiding a laser beam provided by a laser unit by a reflected light device through a microscope objective of a microscope onto the sample region, and
moving the laser beam via a laser deflection device.

13. The laser microdissection method according to claim 11, further comprising filtering the sample particles out of the suspension.

14. The laser microdissection method according to claim 11, wherein the sample includes a plurality of tissue layers, further comprising extracting sample particles from just one or from a defined number of the tissue layers.

15. The laser microdissection method according to claim 12, further comprising producing a depression in the sample by the laser beam.
